(19) United States
(12) Patent Application Publication
(10) Pub. No.: US 2014/0184522 A1
(43) Pub. Date: Jul. 3, 2014

(54) TOUCH-SENSITIVE DISPLAY PANEL

(71) Applicants: WINTEK (CHINA) TECHNOLOGY LTD., Dongguan City (CN); WINTEK CORPORATION, Taichung City (TW)

(72) Inventor: JYH-YEUAN MA, TAO YUAN CITY (TW)

(73) Assignees: WINTEK CORPORATION, Taichung City (TW); WINTEK (CHINA) TECHNOLOGY LTD., Dongguan City (CN)

(21) Appl. No.: 13/730,396

(22) Filed: Dec. 28, 2012

(51) Int. Cl. G06F 3/041

(52) U.S. Cl. CPC G06F 3/041
USPC 345/173

(57) ABSTRACT

A touch-sensitive display panel includes a first substrate, a second substrate, a display medium layer, a counter electrode layer and an active device matrix. The active device matrix includes a plurality of scan lines, a plurality of data lines and a plurality of active devices. When the touch-sensitive display panel is touched, touch positions are recognized by detecting variations in a first RC time constant and a second RC time constant, the first RC time constant varies according to variations in a coupling capacitance formed between at least part of the scan lines being touched and the counter electrode layer, and the second RC time constant varies according to variations in a coupling capacitance formed between at least part of the data lines being touched and the counter electrode layer.

### BACKGROUND OF THE INVENTION

a. Field of the Invention

The invention relates to a touch-sensitive display panel and, more particularly, to a touch-sensitive display panel having a simple configuration and fine display quality.

b. Description of the Related Art

Nowadays, since electronic technology is flourishing and wireless communications and the internet are widely used, various electronic devices become vital to our daily life. However, a typical input/output (I/O) interface of an electronic device, such as a keyboard or a mouse, may suffer difficulties during operation to a certain degree. In contrast, a touch panel may provide a straightforward and simple I/O interface and thus is often used as a human-machine interface to control an electronic device.

Typically, different touch screen technologies may include, for example, resistive, capacitive, optical and surface acoustic wave (SAW). A current trend in touch screen technologies is towards integrating touch-sensing functions into a display panel. Taking most commonly used resistive-type touch panels and capacitive-type touch panels as an example, a double-layered electrode structure is needed to perform scanning and sensing operations. Therefore, at least two electrode layers are additional needed to provide a display panel with touch-sensing functions to complicate fabrication processes.

Besides, the additional two electrode layers may reduce light-transmittance and hence lower display quality of an integrated touch-sensitive display panel. Accordingly, it is an important issue to integrate touch-sensing functions into a display panel with simplified fabrication processes and competent display quality.

### BRIEF SUMMARY OF THE INVENTION

The invention provides a touch-sensitive display panel having touch-sensing functions without the formation of additional electrode layers and having a simple configuration, simplified fabrication processes and fine display quality.

The invention provides a touch-sensitive display panel having high sensitivity, where variations in line loadings of at least part of scan lines and data lines are detected to recognize touch positions.

In order to achieve one or a portion of or all of the objects or other objects, one embodiment of the invention provides a touch-sensitive display panel having a first substrate, a second substrate, a display medium layer, a counter electrode layer and an active device matrix. The second substrate is disposed opposite the first substrate, and the display medium layer is disposed between the first substrate and the second substrate. The counter electrode layer is disposed on the second substrate and between the second substrate and the display medium layer. The active device matrix is disposed on the first substrate and between the first substrate and the display medium layer. The active device matrix includes a plurality of scan lines, a plurality of data lines and a plurality of active devices, the scan lines and the data lines extend in mutually different directions, and each of the active devices is electrically connected to one of the scan lines and one of the data lines. When the touch-sensitive display panel is touched, touch positions are recognized by detecting variations in a first RC time constant and a second RC time constant, the first RC time constant varies according to variations in a coupling capacitance formed between at least part of the scan lines being touched and the counter electrode layer, and the second RC time constant varies according to variations in a coupling capacitance formed between at least part of the data lines being touched and the counter electrode layer.

According to the above embodiments, intrinsic components (such as scan lines and data lines) of a display panel are allowed to function as touch-sensing elements to integrate touch-sensing functions into the display panel to form a touch-sensitive display panel. When the touch-sensitive display panel is touched, part of the scan lines and the data lines corresponding to touch positions may vary in time constants RC to provide a basis for touch-sensing controls. Further, since the touch-sensitive display panel may fulfill touch-sensing controls without the need of independent touch-sensing elements, adverse effects on display quality as a result of an arrangement of the touch-sensing elements and fabrication processes for the touch-sensing elements are both avoided.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a partial cross-section of a touch-sensitive display panel according to an embodiment of the invention.

FIG. 2 shows a schematic diagram illustrating a touch action performed on the touch-sensitive display panel shown in FIG. 1.

FIG. 3 shows a schematic diagram of a driver circuit of a touch-sensitive display panel according to an embodiment of the invention.

FIG. 4 shows a waveform diagram of signals transmitted by scan lines and data lines of the touch-sensitive display panel shown in FIG. 3.

FIG. 5 shows a schematic diagram of a driver circuit of a touch-sensitive display panel according to another embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

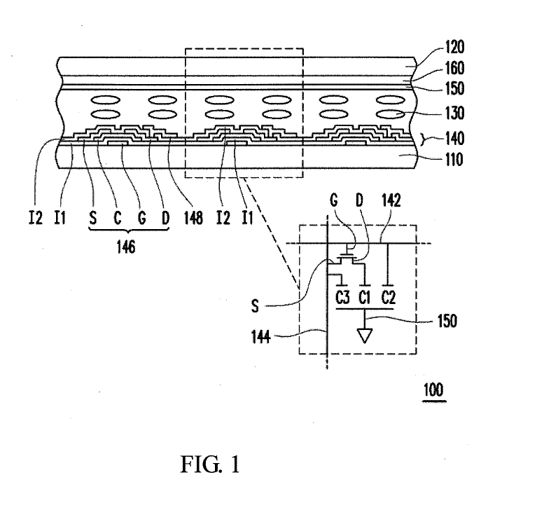

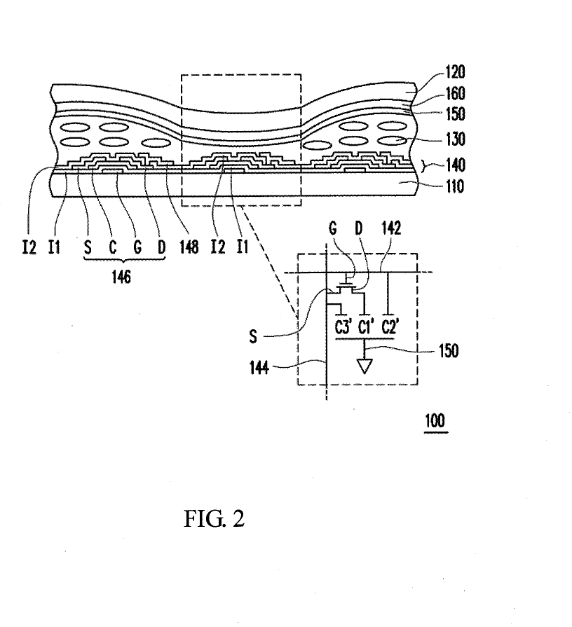

FIG. 1 shows a partial cross-section of a touch-sensitive display panel according to an embodiment of the invention, where a circuit unit of the touch-sensitive display panel is exemplified in a dashed-line box. FIG. 2 shows a schematic diagram illustrating a touch action performed on the touch-sensitive display panel shown in FIG. 1. Referring to FIG. 1, a touch-sensitive display panel 100 includes a first substrate 110, a second substrate 120, a display medium layer 130, an active device matrix 140 and a counter electrode layer 150. The second substrate 120 is disposed opposite the first substrate 110, and the display medium layer 130 is disposed between the first substrate 110 and the second substrate 120. The counter electrode layer 150 is disposed on the second substrate 120 and positioned between the second substrate 120 and the display medium layer 130. The active device matrix 140 is disposed on the first substrate 110 and between the first substrate 110 and the display medium layer 130. The display medium layer 130 may include at least one of a liquid crystal material, an electrophonic material, and an electrowetting material. The display medium layer 130 is activated by the active device matrix 140 to form different states so as to realize display effects. In one embodiment, a color filter layer 160 is optionally disposed on the second substrate 120 to effect color display. In an alternate embodiment, the color filter layer 160 may be formed as a color-filter-on-array (COA) structure or an array-on-color-filter (AOC) structure.

Specifically, the active device matrix 140 may include multiple scan lines 142, multiple data lines 144, and multiple active devices 146. The scan lines 142 and the data lines 144 extend in mutually different directions, and each of the active devices 146 is electrically connected to one of the scan lines 142 and one of the data lines 146. Besides, the active device matrix 140 may include multiple pixel electrodes 148 and insulation layers I1 and I2. Each of the pixel electrodes 148 is electrically connected to one of the active devices 146. Besides, surrounding components are insulated from each other by the insulation layers I1 and I2, where the insulation layer I1 covers the gate G of an active device 146, and the insulation layer I2 is disposed between the pixel electrode 148 and the source S/drain D of the active device 146.

Each active device 146 may have a gate G, a channel layer C, a source S, and a drain D. The channel layer C is disposed above the gate G, and the source S and the drain D are disposed on the channel layer C and respectively on two opposite sides of the gate G. The gate G is electrically connected to one of the scan lines 142, and the source S is electrically connected to one of the data lines 144. In this embodiment, the active device 146 is exemplified as a bottom gate TFT, and the pixel electrode 148 is connected to the drain D. When a signal transmitted by a scan line 142 activates an active device 146, a data signal transmitted by a data line 144 is sent to the pixel electrode 148 via the active device 146. The display medium layer 130 has different states that are formed as a result of variations in a voltage difference between the pixel electrode 148 and the counter electrode layer 150 to realize display effects.

In this embodiment, part of the display medium layer 130 is interposed between the pixel electrodes 148 and the counter electrode layer 150 to form a display capacitance C1, part of the display medium layer 130 is interposed between the scan lines 142 and the counter electrode layer 150 to form a coupling capacitance C2, and part of the display medium layer 130 is interposed between the data lines 144 and the counter electrode layer 150 to form a coupling capacitance C3. In this embodiment, the second substrate 120 is flexible, and therefore relative positions of surrounding components of the touch-sensitive display panel 100 may vary when the touch-sensitive display panel 100 is touched to bend the second substrate 120, as shown in FIG. 1 and FIG. 2. For example, a distance between the counter electrode layer 150 and the first substrate 110 is shortened as a result of a touch action. Under the circumstance, as shown in FIG. 2, the coupling capacitance C2 formed on at least part of the scan lines 142 being touched is increased to become a coupling capacitance C2′, the coupling capacitance C3 formed on at least part of the data lines 144 being touched is increased to become a coupling capacitance C3′, and the display capacitance C1 is also changed to a display capacitance C1′.

Typically, the coupling capacitance C2 represents the entire line loading of each scan line 142, the coupling capacitance C3 represents the entire line loading of each data line 144, and thus the coupling capacitances C2 and C3 are larger than the display capacitance C1. For example, the display capacitance (liquid crystal capacitance) C1 is normally equal to about 0.5 pF, and the coupling capacitance C2 and the coupling capacitance C3 are normally equal to about 20 pF. Therefore, once the touch-sensitive display panel 200 is touched, variations in the coupling capacitance C2′ and the coupling capacitance C3′ is far larger than a variation in the display capacitance C1′. Since a resistance R exists in each of the scan lines 142 and the data lines 144, the resistance R and the coupling capacitance C2 on each scan line 142 may form an RC time constant RC2, and the resistance R and the coupling capacitances C3 on each data line 144 may form an RC time constant RC3. In this embodiment, the width and length of each of the scan lines 142 and data lines 144 are constant, so the resistance R is also kept constant. However, the capacitance C2 on a scan line 142 and the capacitance C3 on a data line 144 may vary when the touch-sensitive display panel 200 is touched, and thus the RC time constants of the scan lines 142 and data lines 144 vary accordingly.

According to the aforementioned characteristics, when the touch-sensitive display panel 100 is touched, touch positions are recognized by detecting variations in a first RC time constant and a second RC time constant. The first RC time constant varies according to variations in the coupling capacitance C2 formed between at least part of the scan lines 142 being touched and the counter electrode layer 150, and the second RC time constant varies according to variations in the coupling capacitance C3 formed between at least part of the data lines 144 being touched and the counter electrode layer 150. In other words, touch positions are allowed to be accurately recognized simply by detecting which of the scan lines and the data lines vary in line loadings (i.e., RC time constants). Therefore, touch-sensing controls are realized without additional elements to eliminate fabrication processes and costs of additional elements and to prevent additional elements from imposing adverse effects on display quality. Thus, the touch-sensitive display panel 100 may have fine display quality without being influenced by the integration of touch-sensing functions. Further, compared with the conventional method where variations in the display capacitance C1 are measured to realize touch-sensing controls, variations in line loadings of the scan lines 142 and the data lines 144 are detected according to the above embodiments to achieve high-sensitivity.

Further, according to the above embodiments, each touch-sensing operation is not limited to associate itself with only one scan line 142 and only one data line 144 but may instead with multiple adjacent scan lines 142 and multiple adjacent data lines 144. That is, a touch-sensing operation may be performed on multiple adjacent scan lines 142 and multiple adjacent data lines 144 at one time.

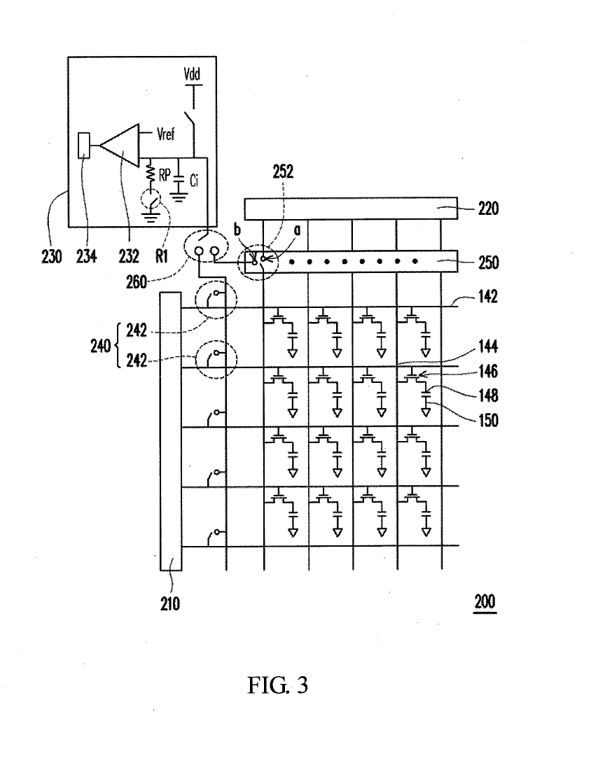

FIG. 3 shows a schematic diagram of a driver circuit of a touch-sensitive display panel according to an embodiment of the invention. Referring to FIG. 3, the touch-sensitive display panel 200 may include an active device matrix 140 (shown in FIG. 2), a counter electrode layer 150, a gate driver circuit 210, a source driver circuit 220, a touch-sensing circuit 230, a first switch group 240, and a second switch group 250. The active device matrix 140 may include multiple scan lines 142, multiple data lines 144, multiple active devices 146, and multiple pixel electrodes 148. In this embodiment, the spatial relationships between the scan lines 142, the data lines 144, the active devices 146, the pixel electrodes 148 and the counter electrode layer 150 are not limited and may be referred to the aforementioned embodiments.

In this embodiment, the scan lines 142 are electrically connected to the touch-sensing circuit 230 one after one through the first switch group 240. Besides, the data lines 144 may be optionally electrically connected to the source driver circuit 220 through the second switch group 250 or successively electrically connected to the touch-sensing circuit 230. The first switch group 240 may include multiple switches' 242, and the second switch group 250 may include multiple switches 252.

Specifically, each of the scan lines 142 is connected with the gate driver circuit 210, and the gate driver circuit 210 successively transmits a scan signal to each of the scan lines 142. In this embodiment, the switches 242 also successively connect corresponding scan lines 142 to the touch-sensing circuit 230 according to an input sequence of the scan signal. In other words, each scan line 142 is meanwhile connected to the touch-sensing circuit 230 on receiving a scan signal to perform a touch-sensing operation. In this embodiment, the switch 252 may be a dual-port switch having a first node a and a second node b, so each data line 144 is allowed to be switched between the first node a and the second node b to link the source driver circuit 220 or the touch-sensing circuit 230. That is, the data lines 144 are used to perform image display and touch-sensing controls at different times.

In the touch-sensitive display panel 200, variations in the capacitances detected on the scan lines 142 and the data lines 144 serve as a basis for touch-sensing controls. Therefore, the touch-sensing circuit 230 is adapted to sense capacitance variations. For example, the touch-sensing circuit 230 may include a preset capacitor Ci, a resistor RP connected with the preset capacitor Ci, a comparator 232 and a counter 234. The resistor RP is grounded when a switch R1 is turned on to allow each scan line and each data line to perform touch-sensing operations. The comparator 232 compares a voltage of the preset capacitor Ci with a reference voltage Vref, and the counter 234 records an elapsed time needed to decrease the voltage of the preset capacitor Ci to a value lower than the reference voltage Vref. Further, the scan lines 142 and the data lines 144 may be alternately connected to the touch-sensing circuit 230 through a switch 260. More specifically, the switch 260 may link the scan lines 142 first to allow the scan lines 142 to perform scanning and sensing operations, and, when operations of the scan lines complete, the switch 260 change to link the data lines 144 to allow the data lines 144 to perform sensing operations.

When the touch-sensing circuit 230 is connected to the scan lines 142 or the data lines 144, the preset capacitor Ci is connected in parallel with a capacitor having the coupling capacitance C2 or a capacitor having the coupling capacitance C3 (shown in FIG. 1). Since an elapsed time needed to decrease the voltage of the preset capacitor Ci to a value lower than the reference voltage Vref is affected by the coupling capacitance C2 or the coupling capacitance C3, the elapsed time is measured to recognize whether the coupling capacitance C2 or the coupling capacitance C3 changes (i.e., estimating variations in the first RC time constant of the scan lines 142 and in the second RC time constant of the data lines 144) to detect touch positions. Certainly, the circuit layout of the touch-sensing circuit 230 is not limited to the embodiment shown in FIG. 3.

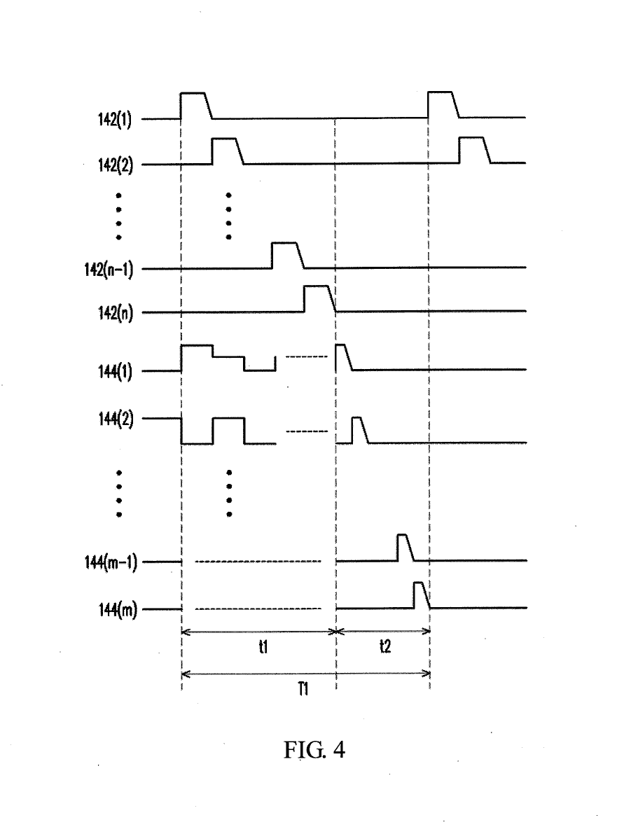

FIG. 4 shows a waveform diagram of signals transmitted by scan lines and data lines of the touch-sensitive display panel shown in FIG. 3. Please refer to both FIG. 3 and FIG. 4, in this embodiment, the number of the scan lines 142 is n, the number of the data lines 142 is m, and the touch-sensitive display panel 200 has a frame time T1 as a refreshing period of a display frame to perform both image display and touch-sensing operations. Therefore, the scan lines 142 are denoted as 142(1), 142(2), . . . 142(n), and the data lines 144 are denoted as 144(1), 144(2), . . . 144(m). In this embodiment, the frame time T1 is divided into a period t1 and a period t2. During the period t1, the switch 260 shown in FIG. 3 may link the first switch group 240 with the touch-sensing circuit 230, and, during the period t2, the switch 260 may link the second switch group 250 with the touch-sensing circuit 230. During the period t1, a scan signal is successively transmitted to scan line 142(1) to scan line 142(n), and meanwhile all the switches 252 of the second switch group 250 are connected to the fist node a to enable the source driver circuit 220 to send data to each active device 146 to effect image display. Besides, when one of the scan lines 142 receives a scan signal, a corresponding switch 242 is enabled to allow that scan line 142 to link the touch-sensing circuit 230. In other words, in this embodiment, the scan lines 142 may perform scanning and touch-sensing operations at the same time.

Then, during the period t2, the switches 252 are connected to the second node b one after one by a shift resistor to successively connect corresponding data lines 144 to the touch-sensing circuit 230 to perform touch-sensing operations. That is, the touch-sensing circuit 230 may successively sense capacitance variations of the scan lines 142 during the period t1 and successively sense capacitance variations of the data lines 142 during the period t2.

In one embodiment, assume some points on the touch-sensitive display panel 200 crossed by a scan line 142(1), a scan line 142(2), a data line 144(m−1) and a data line 144(m) are touched by an user, the coupling capacitances formed on the scan line 142(1) and the scan line 142(2), such as the coupling capacitance C2′ shown in FIG. 2, are larger than the coupling capacitances formed on the rest scan lines 142 (such as the coupling capacitance C2 shown in FIG. 1). Therefore, counter values fetched by the counter 234 of the touch-sensing circuit 230 upon sensing the scan line 142(1) and the scan line 142(2) are larger than counter values fetched by the counter 234 upon sensing the rest scan lines 142 to detect that the scan line 142(1) and the scan line 142(2) are touched. Similarly, the coupling capacitances formed on the data line 144(m−1) and data line 144(m), such as the coupling capacitance C3′ shown in FIG. 2, are larger than the coupling capacitances formed on the rest data lines 144 (such as the coupling capacitance C3 shown in FIG. 1). Therefore, counter values fetched by the counter 234 of the touch-sensing circuit 230 upon sensing the data line 144(m−1) and data line 144(m) are larger than counter values fetched by the counter 234 upon sensing the rest data lines 144 to detect that data line 144(m−1) and data line 144(m) are touched. Accordingly, the aforementioned operations of this embodiment are allowed to detect touch positions. In this embodiment, all the scan lines 142 of the touch-sensitive display panel 200 are connected to the touch-sensing circuit 230 through the first switch group 24, and all the data lines 144 are connected to the source driver circuit 220 and the touch-sensing circuit 230 through the second switch group 250. Certainly, the scan lines 142 may be successively connected to the touch-sensing circuit 230 by other means except for a switch group, and the data lines 144 may be successively connected to the source driver circuit 220 and the touch-sensing circuit 230 by other means except for a switch group.

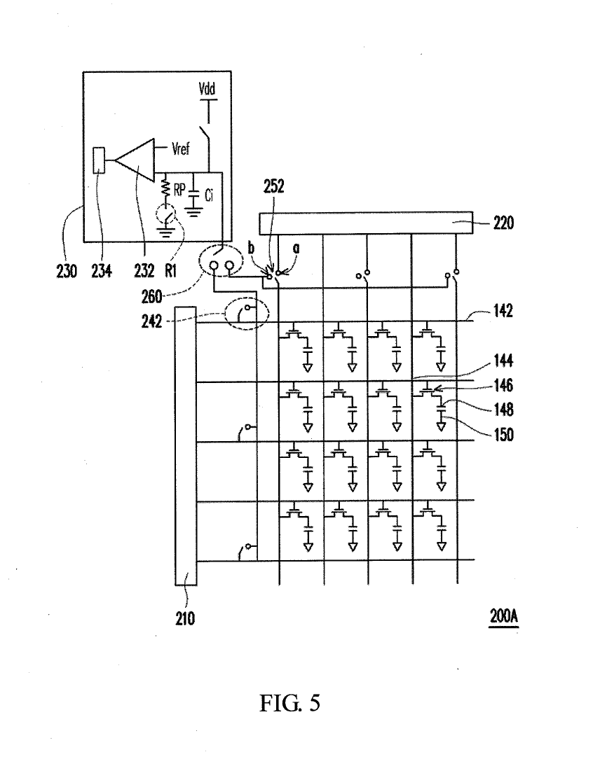

Further, FIG. 5 shows a schematic diagram of a driver circuit of a touch-sensitive display panel according to another embodiment of the invention. Referring to FIG. 5, the touch-sensitive display panel 200A is similar to the touch-sensitive display panel 200, except part of the scan lines 142 (such as odd-numbered scan lines 142) are connected to the touch-sensing circuit 230 through the switches 242, the rest of the scan lines 142 are only connected to the gate driver circuit 210, part of the data lines 144 (such as odd-numbered data lines 144) are alternately connected to the source driver circuit 220 and the touch-sensing circuit 230, and the rest of the data lines 144 are directly connected to the source driver circuit 220.

In this embodiment, only part of the scan lines 142 and part of the data lines 144 of the touch-sensitive display panel 200A are connected to the touch-sensing circuit 230 through switches 242 and switches 252, and the rest of the scan lines 142 and the data lines 144 are directly connected to the gate driver circuit 210 and the source driver circuit 220, respectively. Under the circumstance, only part of the scan lines 142 and part of the data lines 144 are used to perform both touch-sensing and image display operations, and the remainder are only used to perform image display operations

According to the above embodiments, intrinsic components (such as scan lines and data lines) of a display panel are allowed to function as touch-sensing elements to integrate touch-sensing functions into the display panel to form a touch-sensitive display panel. When the touch-sensitive display panel is touched, part of the scan lines and the data lines corresponding to touch positions may vary in time constants RC to provide a basis for touch-sensing controls. Further, since the touch-sensitive display panel may fulfill touch-sensing controls without the need of independent touch-sensing elements, adverse effects on display quality as a result of an arrangement of the touch-sensing elements and fabrication processes for the touch-sensing elements are both avoided.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A touch-sensitive display panel, comprising:
a first substrate;
a second substrate disposed opposite the first substrate;
a display medium layer disposed between the first substrate and the second substrate;
a counter electrode layer disposed on the second substrate and between the second substrate and the display medium layer; and
an active device matrix disposed on the first substrate and between the first substrate and the display medium layer, wherein the active device matrix comprises a plurality of scan lines, a plurality of data lines and a plurality of active devices, the scan lines and the data lines extend in mutually different directions, and each of the active devices is electrically connected to one of the scan lines and one of the data lines;
wherein, when the touch-sensitive display panel is touched, touch positions are recognized by detecting variations in a first RC time constant and a second RC time constant, the first RC time constant varies according to variations in a coupling capacitance formed between at least part of the scan lines being touched and the counter electrode layer, and the second RC time constant varies according to variations in a coupling capacitance formed between at least part of the data lines being touched and the counter electrode layer.

2. The touch-sensitive display panel as claimed in claim 1, further comprising: a gate driver circuit, a source driver circuit and a touch-sensing circuit, wherein the scan lines are electrically connected to the gate driver circuit or the touch-sensing circuit, and the data lines are electrically connected to the source driver circuit or the touch-sensing circuit.

3. The touch-sensitive display panel as claimed in claim 2, further comprising: a first switch group, wherein at least part of the scan lines are connected to the first switch group and electrically connected to the gate driver circuit or the touch-sensing circuit through the first switch group.

4. The touch-sensitive display panel as claimed in claim 2, further comprising: a second switch group, wherein at least part of the data lines are connected to the second switch group and electrically connected to the source driver circuit or the touch-sensing circuit through the second switch group.

5. The touch-sensitive display panel as claimed in claim 1, wherein, when the touch-sensitive display panel is touched, touch positions are recognized by detecting variations in the first RC time constant of all the scan lines and the second RC time constant of all the data lines.

6. The touch-sensitive display panel as claimed in claim 1, wherein the active device matrix further comprises a plurality of pixel electrodes, and each of the pixel electrodes is electrically connected to one of the active devices.

7. The touch-sensitive display panel as claimed in claim 1, wherein each of the active devices comprises a gate, a channel layer, a source and a drain, the channel layer is disposed above the gate, the source and the drain are disposed on the channel layer and respectively on two opposite sides of the gate, the gate is electrically connected to one of the scan lines, and the source is electrically connected to one of the data lines.

8. The touch-sensitive display panel as claimed in claim 1, further comprising: a color filter layer disposed on the first substrate or the second substrate.

9. The touch-sensitive display panel as claimed in claim 1, wherein the display medium layer comprises at least one of a liquid crystal material, an electrophonic material, and an electrowetting material.

10. The touch-sensitive display panel as claimed in claim 1, wherein the second substrate is flexible.
